(19) United States
(12) Patent Application Publication
(10) Pub. No.: US 2013/0278734 A1
(43) Pub. Date: Oct. 24, 2013

(54) METHOD AND SYSTEM FOR GENERATING DYNAMIC ADS WITHIN A VIDEO GAME OF A PORTABLE COMPUTING DEVICE

(71) Applicant: QUALCOMM Incorporated, San Diego, CA (US)

(72) Inventors: Ruiduo Yang, San Diego, CA (US); Mark H. Feldman, San Diego, CA (US); Donald W. Gillies, San Diego, CA (US); Rajat Gupta, San Diego, CA (US); Aleksandra L. Krstic, San Diego, CA (US); Kun Zhang, San Diego, CA (US); Anubha Jayaswal, San Diego, CA (US); Peter Andic, Cambridge (GB)

(21) Appl. No.: 13/924,548

(22) Filed: Jun. 22, 2013

Related U.S. Application Data
(63) Continuation of application No. 13/181,389, filed on Jul. 12, 2011.
(60) Provisional application No. 61/450,308, filed on Mar. 8, 2011.

(51) Int. Cl. G06Q 30/02; H04N 13/04

(52) U.S. Cl. CPC G06Q 30/0241; H04N 13/0468
USPC 348/51

(57) ABSTRACT

A method and system for generating and tracking dynamic advertisements within a program, such as a video game, running on a portable computing device (PCD) are described. The method and system include receiving a call from the program for a texture and reviewing an identifier associated with the texture. A graphics driver determines if the identifier associated with the texture matches an identifier in a texture database. The graphics driver then selects a dynamic advertisement from a texture database if the identifier associated with the texture matches the identifier in the texture database. The graphics driver issues commands to the graphics processor so that dynamic advertisement is presented on a screen display. The graphics driver then determines if a video object produced by the program blocks a portion of the dynamic advertisement present on the screen display.

### PRIORITY AND RELATED APPLICATIONS STATEMENT

This application claims priority under 35 U.S.C. §119(e) to provisional patent application Ser. No. 61/450,308, filed on Mar. 8, 2011, and entitled, “METHOD TO SUPPORT DYNAMIC EMBEDDED ADS IN MOBILE GAMES.” The entire contents of which are hereby incorporated by reference.

### DESCRIPTION OF THE RELATED ART

Portable computing devices (“PCDs”) are becoming necessities for people on personal and professional levels. These devices may include cellular telephones, portable/personal digital assistants (“PDAs”), portable game consoles, portable navigation units, palmtop computers, and other portable electronic devices.

PCDs may run software for providing entertainment. Such software includes video games. Many video games provide a user experience that simulates real life. For example, some three-dimensional video games generate real world scenes with perspective/depth perception that include objects such as buildings, sports stadiums, billboards, and signs.

Many video games generate “real-looking” advertisements within these real world scenes such as on the billboards and signs. For example, a three-dimensional video game depicting a stadium may display advertisements of real world brands for goods and services on billboards and signs in this three-dimensional “game world.” These advertisements may be often referred to as “in-game Ads” as understood by one of ordinary of skill in the art. These real world brands of goods and services may be available to purchase outside of the game world itself. Such advertising of brands for goods and services within the context of a three dimensional video game are generally referred to in the art as embedded Ads.

One problem in the art is that most embedded Ads within video games are “static.” This means that the advertisements usually remain the same whenever a video game program is executed. These advertisements within video game programs are usually never interactive with the user. That is, video game developers typically do not provide advertisements that are dynamic in which Ads may be changed either during the game or the next time the game is played. Conventional Ads within games usually do not allow a user to select aspects of an advertisement within a game in order to obtain more information about a product or service being advertised.

Since video game developers do not provide for interactive advertisements within video game software, they are unable to tap into a significant amount of potential revenue from product providers and service providers who may wish to advertise within a game. Without interactive advertising and the ability to make Ads more dynamic within video games, game developers are not realizing the full potential of providing advertisements within a gaming experience.

Accordingly, what is needed in the art is a method and system that addresses these problems. Specifically, a method and system is needed in the art for making advertisements within a video game more dynamic. A method and system is needed for providing interactive advertising within a game on a PCD that allows for the tracking of advertisements and user interaction with such advertisements.

### SUMMARY

A method and system for generating and tracking dynamic advertisements within a program, such as a video game, running on a portable computing device (PCD) are described. The method and system include receiving a call from the program for a texture and reviewing an identifier associated with the texture. A graphics driver determines if the identifier associated with the texture matches an identifier in a texture database. The graphics driver then selects a dynamic advertisement from a texture database if the identifier associated with the texture matches the identifier in the texture database. The graphics driver issues commands to the graphics processor so that the dynamic advertisement is presented on a screen display. The graphics driver then determines if a video object produced by the program blocks a portion of the dynamic advertisement present on the screen display. The graphics driver may also determine if a screen pointer, such as an underbar or highlight controlled by the keyboard or a pointer controlled by a computer mouse, interacts with any portion of the dynamic advertisement.

### BRIEF DESCRIPTION OF THE DRAWINGS

In the figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating exemplary elements of a system for generating dynamic advertisements within a PCD video game;

FIG. 2 is a functional block diagram illustrating an embodiment of a portable computing device (PCD) having the system for generating dynamic advertisements within a PCD video game;

FIG. 3A is a diagram of an exemplary display screen comprising a fully blocked view of an advertisement in a PCD video game;

FIG. 3B is a diagram of an exemplary display screen comprising a partially blocked view of an advertisement in a PCD video game;

FIG. 3C is a diagram of an exemplary display screen comprising an unblocked (visible) view of an advertisement in a PCD video game;

FIG. 3D is a diagram of a screen display generated in response to a selection of or “mouse click” on an advertisement provided in a PCD video game;

FIG. 4 is a functional block diagram illustrating an exemplary components of a system for generating dynamic advertisements in a PCD video game;

FIG. 5 is a logical flowchart illustrating a method for generating dynamic advertisements in a PCD video game; and

FIG. 6 is a logical flowchart illustrating a submethod or routine for determining if a dynamic advertisement within a PCD video game is blocked from view relative to the operator of the PCD;

FIG. 7 is a chart illustrating exemplary contents of a texture database; and

FIG. 8 is a chart illustrating exemplary tracking options for dynamic advertisements within a PCD video game.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” and “wireless handset” are used interchangeably. With the advent of third generation (“3G”) and fourth generation (“4G”) wireless technology, greater bandwidth availability has enabled more portable computing devices with a greater variety of wireless capabilities.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“30”) and fourth generation (“4G”) wireless technology, have enabled numerous PCDs with multiple capabilities. Therefore, a PCD may be a cellular telephone, a satellite telephone, a pager, a personal digital assistant (“PDA”), a smartphone, a navigation device, a smartbook or reader, a media player, a combination of the aforementioned devices, and a laptop computer with a wireless connection, among others.

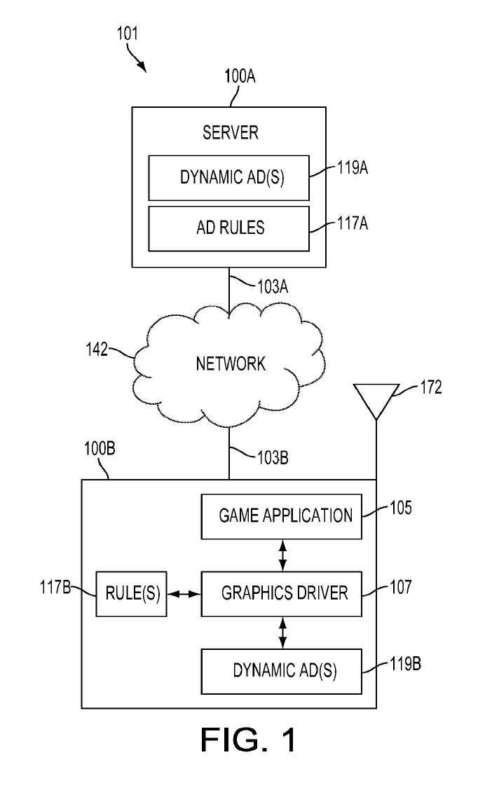

FIG. 1A is a functional block diagram illustrating exemplary elements of a system 101 for generating dynamic advertisements (“Ads”) 119 within a portable computing device (“PCD”) video game. The system 101 may comprise a PCD 100B and a computer server 100A. Many of the system elements illustrated in FIG. 1A are coupled via communications links 103 to the communications network 142A.

The links 103 illustrated in FIG. 1A may comprise wired or wireless links. Wireless links include, but are not limited to, radio-frequency (“RF”) links, infrared links, acoustic links, and other wireless mediums. The communications network 142A may comprise a wide area network (“WAN”), a local area network (“LAN”), the Internet, a Public Switched Telephony Network (“PSTN”), a paging network, or a combination thereof. The communications network 142A may be established by broadcast RF transceiver towers. However, one of ordinary skill in the art recognizes that other types of communication devices besides broadcast RF transceiver towers are available for establishing the communications network 142A. The PCD 100B is shown to have an antenna 172 so that a respective PCD 100B may establish wireless communication links 103B with the communications network 142A via RF transceiver towers.

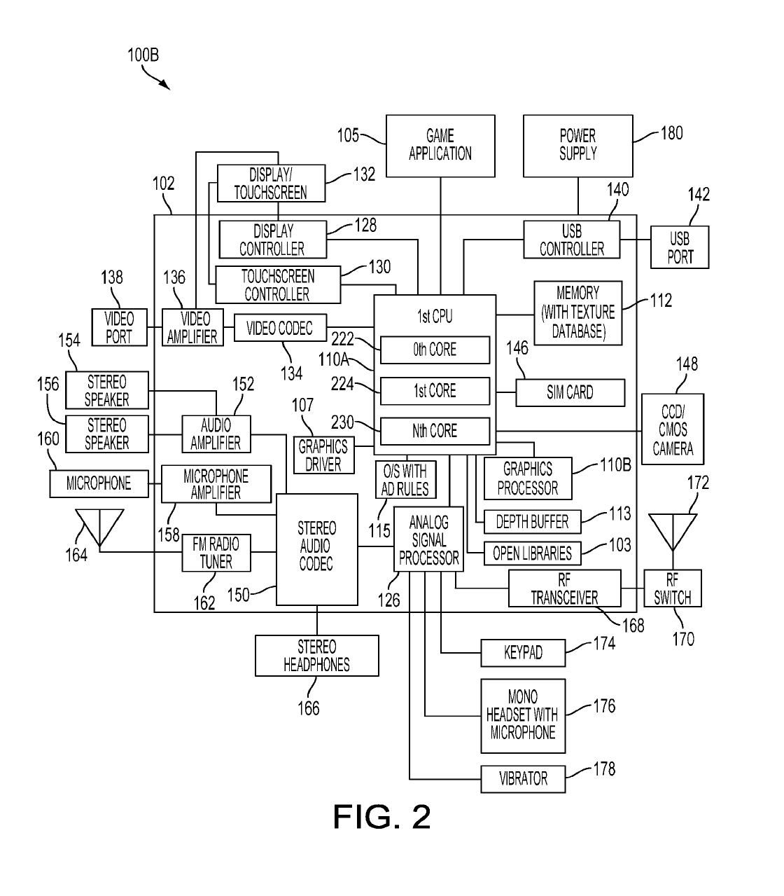

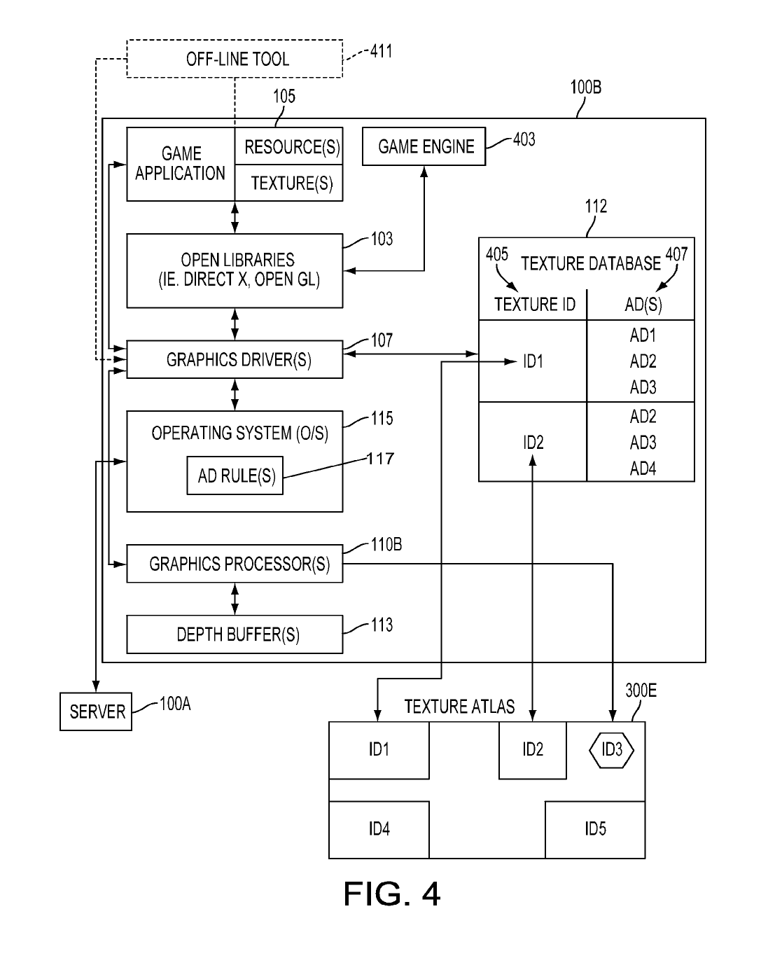

The PCD 100B may comprise a graphics driver module 107 (hereinafter, “graphics driver” 107). The graphics driver 107 usually comprises one or more software modules. However, the graphics driver 107 may be implemented in hardware as understood by one of ordinary skill in the art. The graphics driver 107 may support graphics calls from the game application module 105 to produce visible objects on a display screen 132 (See FIG. 2). The graphics driver may control a dedicated processor such as a graphics processor 110B (See FIG. 2) as understood by one of ordinary skill in the art. The graphics driver 107 may access and use Advertisement (“Ad”) rules 117 (See FIG. 4) that may be part of or supported by an operating system for the PCD 100B. The Ad rules 117 may assist the graphics driver 107 in selecting a dynamic Ad 119B for display on a display screen 132. The Ad rules 117A may be created and managed by the server 100A. The server 100A may transmit the Ad rules 117 over the computer network 142 to the PCD 100B for storage in the OS 115 with Ad rules 117. The dynamic Ads 119B may also originate with the server 100A and may also be transmitted over the computer network 142 to the PCD 100B.

The dynamic Ads 119 (See FIG. 1) may include tracking features such as those found in Ad campaigns as understood by one of ordinary skill in the art. Further details about the dynamic Ads 119 will be described below in connection with FIG. 7 and FIG. 8. The dynamic Ads 119 may be changed each time the game application module 105 is played (executed) and/or during an iteration or “game round” while the game application module 105 is played.

For example, in a three-dimensional PCD video game supported by the game application 105, a stadium for a race car track may be depicted. The PCD video game may provide for a racing experience for the operator of the PCD 100B. Adjacent to the race car track within the stadium, the PCD videogame may display virtual billboards that may carry dynamic Ads 119B. For example, a dynamic Ad 119B may comprise an alphanumeric text based advertisement for a certain brands of car tires that are available in the real world outside of the game world being produced by the PCD video game.

The graphics driver 107 may select particular brands for display on the virtual billboards within the game world according to the Ad rules 117. The Ad rules 117 may be supported by an operating system of the PCD 100B. For example, the graphics driver 107 may select a first brand of tires to display on a display screen 132 during a first round or play or level of the videogame. The graphics driver 107 may select a second brand of tires to display on the display screen 132 during a second round or play or level of the videogame. The graphics driver's ability to select different Ads in each situation is what makes the Ads dynamic. Further details about the Ad rules 117 and how the dynamic Ads 119 were selected according to these Ad rules 117 will be described below in connection with FIGS. 4-8.

The computer server 100A may comprise a database of dynamic Ads 119B and Ad rules 117A. The computer server 100A may receive input from product and service vendors who generate dynamic Ads 119B that may advertise particular brands of goods or services or both. The server 100A may update the dynamic Ads 119B stored in the PCD 100B by transmitting its dynamic Ads 119A that it maintains in its database over the computer network 142 to the PCD 100B. The PCD 100B may store important dynamic Ads 119 and Ad rules 117B in a memory device, such as memory that is managed as a software cache. This storage may reduce the need for frequent transmission of the Ads 119 and rules 117B over the computer network 142 to the PCD 100B. The memory device may be used to access the most recently used dynamic Ad if access to the computer network 142 and/or the computer server 100A is unavailable.

As illustrated in FIG. 1, the server 100A may update the Ad rules 117B in the OS 115 stored on the PCD 100B by replacing the Ad rules 117B in the OS 115 with new Ad rules 117A maintained at the server 100A. The PCD 100B may update its Ad rules 117B in the OS 115 and its dynamic Ads 119B each time the PCD 100B accesses the server 100A.

### FIG. 2: Dynamic Advertisement System Elements of PCD 100B

Referring to FIG. 2, this figure is a functional block diagram of an exemplary, non-limiting aspect of a PCD 100B in the form of a wireless telephone for implementing methods and systems for generating dynamic advertisements within a PCD video game. As shown, the PCD 100B includes an on-chip system 102 that has a multi-core, central processing unit (“CPU”) 110A, a graphics processor 110B, and an analog signal processor 126. These processors 110A, 110B, 126 may be coupled together.

The CPU 110A may comprise a zeroth core 222, a first core 224, up through an Nth core 230 as understood by one of ordinary skill in the art. In an alternate embodiment, instead of using a CPU 110A and a graphics processor 110B, one or more digital signal processors (“DSPs”) may also be employed as understood by one of ordinary skill in the art.

The PCD 100B may comprise a graphics driver 107. One of ordinary skill in the art will recognize that the graphics driver 107 may comprise one or more software modules that may be divided into various parts and executed by different processors 110A, 126 without departing from this disclosure. Alternatively, the graphics driver 107 may be organized as a single element and executed by a single processor 110A or 126.

As noted above, the graphics driver 107 (FIG. 1) may comprise software which is executed by the CPU 110A for receiving communications from the game application 105 and sending commands to the graphics processor 110B. However, the graphics driver 107 may also be formed from hardware and/or firmware as understood by one of ordinary skill in the art. One or more game applications 105 may be responsible for providing PCD video games. The graphics driver 107 may monitor and track the game application 105 for user actions. User actions may comprise mouse pointer movement and/or keystrokes in connection with the dynamic Ads 119B (FIG. 1) generated by the graphics processor 110B that are displayed on the display screen 132.

The PCD 100B may further comprise operating system (“O/S”) software 115 that manages the communications between the CPU 110A and the hardware and other software illustrated. The O/S software 115 may further comprise the Ad rules 117 as described above. The Ad rules 117 may provide the logic for selecting certain dynamic Ads 119 for display on the display screen 132 during a PCD video game based on defined conditions. Examples of defined conditions include, but are not limited to, user preferences, user zipcode, user's gender, user's age, user's household income (perhaps deduced from user's zipcode), and game genre.

The PCD 100B may further comprise a depth buffer 113 (FIG. 2). The depth buffer 113 may also be referred to as a z-buffer as understood by one of ordinary skill in the art. The depth buffer 113 may comprise hardware or software or both. The depth buffer 113 manages image depth coordinates in three-dimensional (“3-D”) graphics as understood by one of ordinary skill in the art. The depth buffer 113 may comprise memory that stores the depth value at every pixel in 3-D graphics of PCD video games. The depth buffer 113 may record the depth values of objects which are displayed on the display screen 132 during a PCD video game. The depth buffer 113 may communicate with the graphics processor 110B and the graphics driver 107.

The PCD 100B may further comprise one or more open graphics libraries 103 for creating graphics presentations such as video games. The one or more open graphics libraries 103 may include, but are not limited to, libraries like DirectX™ and OpenGL™. The one or more open graphics libraries may comprise a multi-platform software interface that communicates with the graphics processing unit 110B, supporting rendering and imaging operations. The one or more open graphics libraries 103 may comprise a graphics interface that includes a plurality of functions operating on two-dimensional (“2-D”) and three-dimensional (“3D”) objects for viewing on the display screen 132.

The one or more open graphics libraries 103 may support basic graphics rendering techniques, such as modeling and smooth shading, and advanced techniques, such as texture mapping and motion blur, vertex and fragment shaders which access textures to produce special effects. These effects may include, but are not limited to, motion blur, depth of field, particle effects, water simulation, etc. The one or more open graphics libraries 103 may support and interact with a frame buffer for rendering video images on the display screen 132.

The PCD 110B may also comprise memory 112 that includes a texture database. Texture information within the texture database may be derived from prebuilt hash tables. Texture information includes adding detail, surface texture (a bitmap or raster image), or color to a computer-generated graphic or 3D model. For example, texture information represented by a bitmap or raster image includes normal maps (for shading), transparency, and/or color to a computer-generated graphic or 3D-model. Texture information is generally used in all types of 3-D graphics displayed in games on PCDs 100.

In general, the graphics driver 107 in combination with Ad rules 117 (within the O/S 115) may be responsible for generating dynamic Ads 119B within a PCD video game. Specifically, the graphics driver 107 running on the CPUs 110 may access Ad rules 117 within the O/S 115 and pull textures from the texture information from the texture database stored memory 112 to generate dynamic Ads 119B for viewing on the display screen 132.

In a particular aspect, one or more of the method steps described herein may be implemented by executable instructions and parameters stored in the memory 112 that forms the graphics driver 107. These instructions that form the graphics driver 107 may be executed by the CPU 110, the analog signal processor 126, or another processor. Further, the processors 110A and/or 126, the memory 112, the instructions stored therein, or a combination thereof may serve as a means for performing one or more of the method steps described herein.

### FIG. 2: Other Elements of the PCD 100A

As illustrated in FIG. 2, a display controller 128 and a touchscreen controller 130 are coupled to the digital signal processor 110A. A touchscreen display 132 external to the on-chip system 102 is coupled to the display controller 128 and the touchscreen controller 130.

FIG. 2 is a schematic diagram that illustrates a video encoder 134, e.g., a phase-alternating line (“PAL”) encoder, a sequential couleur avec memoire (“SECAM”) encoder, a national television system(s) committee (“NTSC”) encoder or any other type of video encoder 134 coupled to the multicore central processing unit (“CPU”) 110A. A video amplifier 136 is coupled to the video encoder 134 and the touchscreen display 132. A video port 138 is coupled to the video amplifier 136. As depicted in FIG. 2, a universal serial bus (“USB”) controller 140 is coupled to the CPU 110A. Also, a USB port 142 is coupled to the USB controller 140. A subscriber identity module (SIM) card 146 may also be coupled to the CPU 110A. Further, as shown in FIG. 2, a digital camera 148 may be coupled to the CPU 110A. In an exemplary aspect, the digital camera 148 is a charge-coupled device (“CCD”) camera or a complementary metal-oxide semiconductor (“CMOS”) camera.

As further illustrated in FIG. 2, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 2 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 2 further indicates that a radio frequency (“RF”) transceiver 168 may be coupled to the analog signal processor 126. An RF switch 170 may be coupled to the RF transceiver 168 and an RF antenna 172. As shown in FIG. 2, a keypad 174 may be coupled to the analog signal processor 126. Also, a mono headset with a microphone 176 may be coupled to the analog signal processor 126. Further, a vibrator device 178 may be coupled to the analog signal processor 126. FIG. 2 also shows that a power supply 180, for example a battery, is coupled to the on-chip system 102. In a particular aspect, the power supply 180 includes a rechargeable DC battery or a DC power supply that is derived from an alternating current (“AC”) to DC transformer that is connected to an AC power source.

As depicted in FIG. 2, the touchscreen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, and the power supply 180 are external to the on-chip system 102.

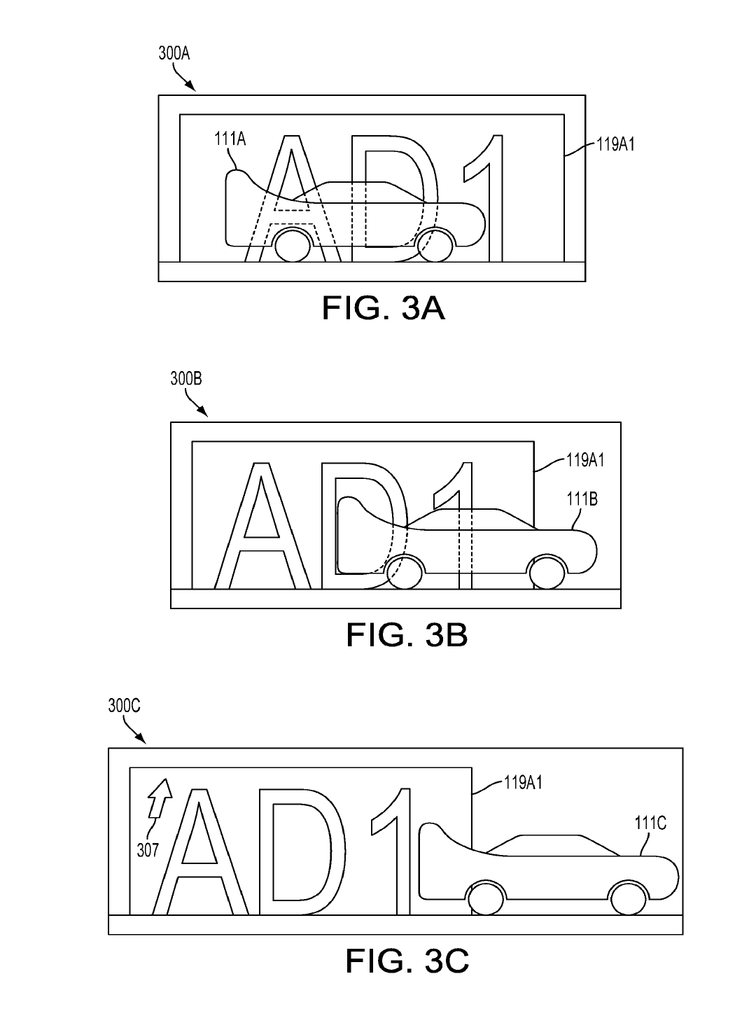

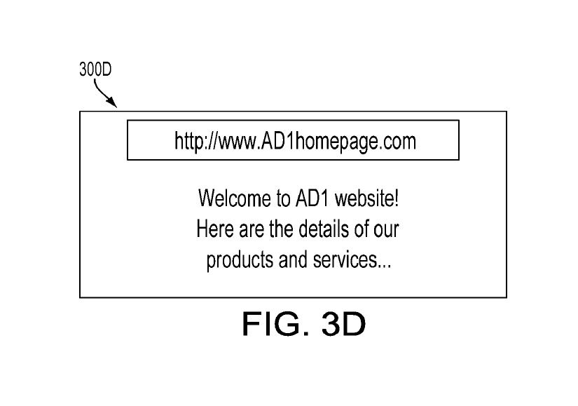

FIG. 3A is a diagram of an exemplary display screen 300A comprising a fully blocked view of an advertisement 119A1 in a PCD video game. According to this exemplary embodiment, the advertisement 119A1 may comprise a rectangular sign having the phrase “AD1.” The PCD video game is generating the video object 111A and the advertisement 119A1. Several of the alphanumeric characters of the phrase “AD1” have been illustrated with dashed lines to indicate that they are not visible or cannot be seen by an operator of the PCD 100B who is playing the PCD video game. Specifically, the alphanumeric characters “A” and “D” of “AD1” have been illustrated with dashed lines to indicate which portions have been blocked by the video object 111A. In some instances, the advertisement 119A1 may not be placed in screen 300A or orthographic to the screen 300A. The advertisement 119A1 may be subject to a non-orthographic/perspective transformation when it appears naturally in the PCD video game on the screen 300A.

As depicted in FIG. 3A, the video object 111A is blocking the full view of the advertisement 119A1. Advertisement 119A1 is formed by an Ad texture mapped onto an object in the scene such as a score board or billboard as illustrated in FIG. 3A. In this exemplary embodiment, the video object 111A comprises a race car. One of ordinary skill the art recognizes that other advertisements besides 119A1 and other types of video objects besides those illustrated in FIG. 3A are within the scope of this disclosure. For example, the video object 111A may comprise a figure of a person or avatar playing a sport and the advertisement 119A1 may comprise an elevated billboard or a banner advertisement positioned on a wall of a virtual three-dimensional stadium.

The depth buffer 113 may determine that the video object 111A may be fully blocking the advertisement 119A1 such that any alphanumeric characters or symbols present on the advertisement 119A1 are not visible and/or not comprehendible by an operator of the PCD 100B who is playing the PCD videogame. The depth buffer 113 makes this determination by assessing the values assigned to the three-dimensional coordinates forming the video object 111A and the advertisement 119A1.

In an alternate embodiment and for example, the depth buffer 113 may determine that the advertisement 119A1 is blocked because one or more “key points” of the advertisement 119A1(determined by the Ad designer) are not visible in the depth buffer, because they are obscured by the race car 111. In a further embodiment and for example, the depth buffer 113 may determine that even though the car 111 is not blocking the advertisement 119A1, too few pixels of the advertisement 119A1 are being displayed (perhaps because the Ad 119A1 is displayed at an angle, or because the Ad 119A1 is too far away), and thus the Ad 119A1 may be effectively “blocked” by being at a great distance or being at a sharp rendering angle. Alternatively, an Ad 119A1 may be stored at several resolutions in a “mipmap” and the Ad designer may indicate how large the Ad 119A1 must be, based on selection among several choices in the “mipmap” before it is considered displayed to the user. The graphics driver 107 may review a sub-picture displayed from a mipmap and using a minimum mipmap Ad size (an attribute of the Ad itself) to decide if the picture is large enough to qualify as an Ad or commercial impression, as understood by one of ordinary skill in the art.

FIG. 3B is a diagram of an exemplary display screen 300B comprising a partially blocked view of an advertisement 119A1 in a PCD video game. The elements of FIG. 3B are substantially similar to those illustrated in FIG. 3A. Therefore, only the differences between FIG. 3A and FIG. 3B will be described below.

According to this exemplary embodiment, compared to FIG. 3A, the video object 111B comprising the race car as illustrated in FIG. 3B has moved across the display screen 300B such that the amount of overlap between the advertisement 119A1 and 111B is substantially less than illustrated in FIG. 3A. Only one of the alphanumeric characters of the phrase “AD1” has been illustrated with dashed lines, the number “1”, to indicate that it is not visible or cannot be seen by an operator of the PCD 100B who is playing the PCD video game.

The depth buffer 113 may be able to quantify the amount of blocking present in FIG. 3B relative to the amount of blocking present in FIG. 3A. For example, the depth buffer 113 may determine that the advertisement 119A1 of FIG. 3B is approximately 20% blocked compared to the approximately 80% blockage of FIG. 3A. In another exemplary embodiment, and as described earlier, the depth buffer 113 may determine that some “key points” of the advertisement 119A1 are visible, but not all “key points” are visible.

FIG. 3C is a diagram of an exemplary display screen 300C comprising an unblocked (visible) view of an advertisement 119A1 in a PCD video game. The elements of FIG. 3C are substantially similar to those illustrated in FIG. 3A. Therefore, only the differences between FIG. 3A and FIG. 3C will be described below.

According to this exemplary embodiment, compared to FIG. 3A, the video object 111B comprising the race car as illustrated in FIG. 3B has moved across the display screen 300C such that the there is no or 0% overlap between the advertisement 119A1 and the video object 111B. Because none of the alphanumeric characters of the phrase “AD1” in advertisement 119A1 are blocked, each has been illustrated with solid lines to indicate that they are visible or can be seen by an operator of the PCD 100B who is playing the PCD video game.

The depth buffer 113 may be able to quantify the amount of blocking present in FIG. 3C relative to the amount of blocking present in FIG. 3A. For example, the depth buffer 113 may determine that the advertisement 119A1 of FIG. 3B has no or 0% blockage compared to the approximately 20% blockage of FIG. 3B and the approximately 80% blockage of FIG. 3A.

Also illustrated in this exemplary embodiment FIG. 3C is a screen pointer 307. A screen pointer 307 is depicted as having a shape of an arrow, however, other shapes are not beyond the scope of this disclosure as understood by one of ordinary skill in the art. The operator of the PCD 100B may manipulate the screen pointer 307 so that it may move across the screen display 300C.

The operator of the PCD 100B may also use the screen pointer to select a portion of the advertisement 119A1. The graphics driver 107 may monitor the movement and activity, such as “selecting,” made with the screen pointer 307 by the operator. The graphics driver 107 may track the exact coordinates which are traversed with the screen pointer 307 over each advertisement 119A1 that is presented on the screen display 300C. The graphics driver 107 may also determine if the screen pointer 307 has been used to select the advertisement 119A1. The graphics driver 107 may need to make a determination if the screen “pick” or movement is meant for game play or Ad selecting.

In response to a selection of or “mouse click” on the advertisement 119A1, the graphics driver 107 may launch an Internet browser application module and open a new window, such as screen display 300D as illustrated in FIG. 3D. The new window or screen display 300D may be generated by the Internet browser application module in order to display more information about the product and/or service that was the subject of the advertisement 119A1. The graphics driver 107 may work with advertisement tracking systems and software as understood by one of ordinary skill the art and as described in further detail below in connection with FIG. 7. The website producing the screen display 300D may be operated and managed by a product vendor or a service vendor or both.

FIG. 4 is a functional block diagram illustrating further exemplary components of a system 101 for generating dynamic Ads in a PCD video game. Similar to that illustrated in FIG. 1, the graphics driver 107 is coupled to the game application module 105 and the graphics processor 110B. The game application module 105 may comprise resources such as textures for displaying video objects 111 as illustrated in FIGS. 3A-3C. The game application 105 communications with the one or more open graphics libraries 103 as discussed above in connection with FIG. 1. The one or more open graphics libraries 103 also communicate with a game engine 403.

The game engine 403 may provide real-time 3D rendering and may be referred to as a “graphics engine,” “rendering engine,” or “3D engine” as understood by one of ordinary skill in the art. The game engine 403 may generally provide a scene graph, which comprises an object-oriented representation of the 3D game world which often simplifies game design and may be used for more efficient rendering of vast virtual game worlds.

As illustrated in FIG. 1 and FIG. 4, the graphics driver 107 may be coupled to a texture database 112. The texture database 112 may comprise a table that includes a texture identification (“ID”) column 405 and an Ad identifier column 407. The texture ID column 405 may comprise alphanumeric characters which are associated with a texture atlas 300E. The texture atlas 300E corresponds with a screen display 300E having a similar shape and layout.

The game application 105 usually contains a library with all the levels of a game, and when playing one particular level of the game the textures are copied into the texture database 112 for fast access by the rendering hardware. After a level is finished the textures are normally overwritten by a new level.

The texture atlas 300E may comprise a large image, or “atlas” which contains many smaller sub-images, each of which is a texture having a texture ID such as ID1, ID2, ID3, ID4, ID5, etc. for some part of a 3D object rendered by the PCD video game. The sub-textures such as ID1-ID5 may of the texture atlas 300E may be rendered by modifying the texture coordinates of the object's uv-map on the atlas 300E, essentially telling it which part of the image its texture is in.

The texture atlas 300E may be treated as a unit by the graphics processor 110B. In particular, because there are less rendering state changes by binding once, it can be faster to bind one large texture once than to bind many smaller textures as they are drawn.

As understood by one of ordinary skill in the art, atlas 300E may comprise uniformly-sized sub-textures or it may comprise textures ID1-ID5 of varying sizes. In the latter case, a graphic design software, such as Maya, usually automatically arranges the textures ID1-ID5 in an efficient manner before sending the textures ID1-ID5 to the graphics CPU 110B. Manual arrangement of the texture atlas 300E is possible. Often a texture will be stored at many different sizes, to reduce artifacts from shrinking the texture greatly and to increase rendering speed; this technique is called “mip mapping.” If using mipmaps, care usually must be taken to arrange the textures ID1-ID5 in such a manner as to avoid sub-images being “polluted” by their neighbors. As understood by one of ordinary skill in the art, a small border between textures may help prevent this pollution by neighbors.

According to an alternate exemplary embodiment, the texture database 112 and texture atlas 300E may be loaded from the game application 105. As the game application 105 loads the texture database 112 and the texture Atlas 300E, it may notice that some textures are marked with a bit for “texture substitute”. In exemplary embodiments, some textures may be marked with a word for “scene type” indicating the ad environment of the game play for this texture. For example, a game application 105 for a sport like American Football may display a bill board with football logos or logos of fast food vendors for an arena sporting event.

As the game application 105 loads the texture atlas 300E, it will automatically make ad choices for the duration of the level. Since each level may last only a few minutes, there is hardly loss of generality in making these choices as the game loads.

In the exemplary embodiment of FIG. 4, the graphics driver 107 may access the Ad rules 117 supported by the operating system 115 in order to determine which dynamic advertisement 119 should be displayed on the display screen 132 during a PCD videogame. The Ad rules 117 may also be responsible for determining which original textures in a video game needs to be replaced.

The graphics driver 107 may also keep memory in reserve (i.e. reserved bits) to allow game developers to indicate which particular textures are desired to be replaced with dynamic Ads 119. This reserve memory may also be used to designate attributes for textures. Attributes of a texture may include, but are not limited to, width, height, colors, and other like parameters. An Ad rule 117 may be created to control textures with the reserved bits and their respective attributes.

Another exemplary Ad rule 117 may comprise a random selection function such that the graphics driver 107 randomly selects the various dynamic Ads 119 that may be assigned to a particular texture ID.

When the Ad rule 117 comprises a random selection function, the graphics driver 107 may randomly select among the three dynamic Ads 119 that have the Ad identifiers AD2, AD3, and AD4 for the texture ID “ID2” in texture database 112 as illustrated in the texture database 112 of FIG. 4. Stated differently, for texture ID2 as illustrated on the texture atlas 300E, this texture may be populated by three different dynamic Ads 119 corresponding to the Ad identifiers AD2, AD3, or AD4. As described above, the graphics driver 107 may update each texture ID after a run or iteration of the PCD videogame or after a completion of a “round” of play during the PCD videogame.

For example, after each time a video object 111A like the race car of FIG. 3 passes a dynamic advertisement 119A1, the graphics driver 107 may change the dynamic advertisement 119A1. The graphics driver 107 may change the dynamic advertisement based on the Ad identifiers assigned to column 407 and the texture identifiers assigned to column 405 of the texture database 112. Specifically, the dynamic advertisement 119A1 having the advertisement with the phrase “AD1” may be changed to a dynamic advertisement 119A1 having the phrase “AD2.”

Another example would be to display a first dynamic advertisement 119A1 comprising a first brand of tires. After the video object 111A comprising a race car passes the dynamic advertisement 119A1 for a second time, then a second dynamic advertisement 119B1 (not illustrated) comprising a second brand of tires may be displayed. The amount of times and the frequency in which a dynamic advertisement 119A1 is changed by the graphics driver 107 may be governed by the Ad rules 117 of the operating system 115.

According to another exemplary embodiment, an offline tool 411 may be provided which works with the game application 105 and graphics driver 107 offline to generate the Ad rules 117. The offline tool 411 may allow the game developer to select any texture in the video game and to select one or more Ads 119 that can be used to replace a particular texture or set of textures when the video game is being played. The offline tool 411 may comprise software that may be executed by the server 100A or PCD 100B (or both). The graphics driver 107 may extract a selected texture in a video game without any need to change the original game. Attributes of an extracted texture may be used to build an Ad rule 117 that matches a texture to one or multiple corresponding Ads 119. Attributes of an extracted texture may include, but are not limited to, width, height, and colors.

As noted previously, the Ad rules 117, and the texture database 112 comprising the Ad identifiers in column 407 as well as the dynamic Ads 119 themselves may be updated by the server 100A. A server 100A may transmit its updates over the computer network 142 to the operating system 115 of the PCD 100B. The frequency for the updates may be controlled by the server 100A or the PCD 100B or both. The dynamic Ads 119 may be updated by the server 100A even while a PCD video game is running as understood by one of ordinary skill in the art.

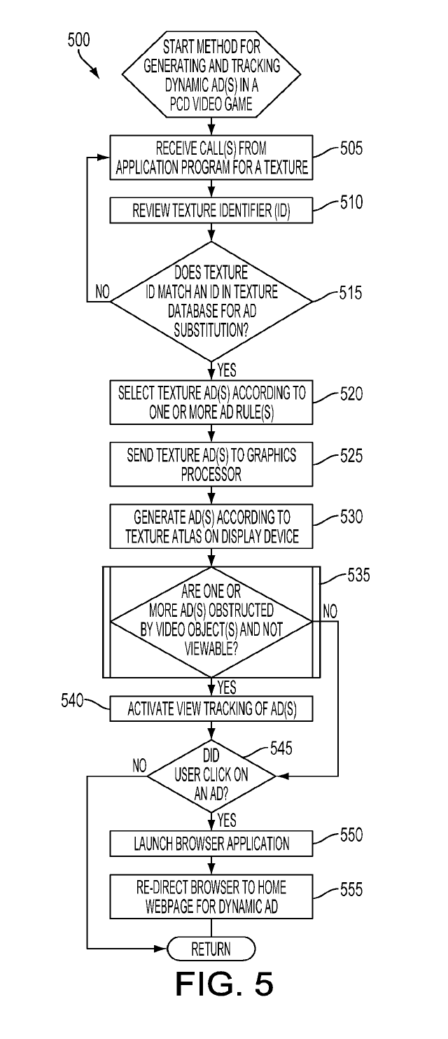

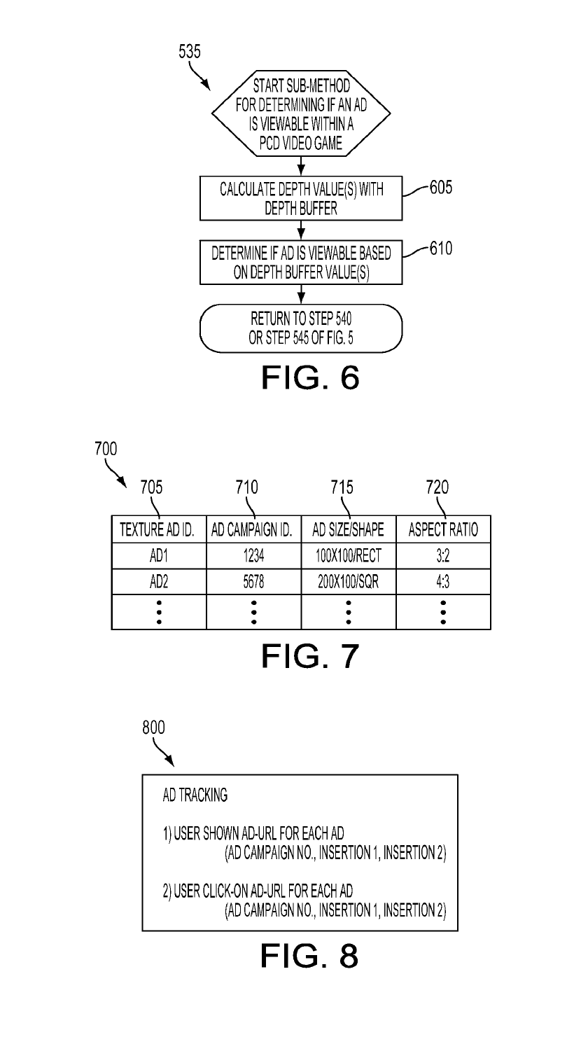

FIG. 5 is a logical flowchart illustrating a method 500 for generating dynamic Ads 119 in a PCD video game. Block 505 is the first step of method 500. In block 505, the graphics driver 107 may receive a call from the game application 105 for a texture for display on a display screen 132 of the PCD 100B. Next, in block 510, the graphics driver 107 may review the texture identifier (“ID”) associated with the call originating from the game application 105.

Next, in decision block 515, the graphics driver 107 may determine if the texture identifier of the call matches a texture ID listed in the texture database 112 for substitution of a dynamic Ad 119. In this decision block 515, the graphics driver 107 may review the table found in the texture database 112 as illustrated in FIG. 4. Specifically, the graphics driver 107 may compare the texture ID column 405 with the texture ID presented by the current texture call being processed.

If the inquiry to this decision block 515 is negative, then the “NO” branch may follow back to block 505. If the inquiry to decision block 515 is positive, then the “YES” branch may be followed to block 520.

In block 520, the graphics driver 107 may select an appropriate Ad identifier from column 407 of the table of the texture database 112 as illustrated in FIG. 4 according to the one or more Ad rules 117 found in the operating system 115. For example, if an Ad rule 117 comprises a random function assigned to a particular texture ID, then the graphics driver 107 may randomly select the Ad identifiers corresponding to the matching texture identifier. One of ordinary skill in the an will recognize that Ad rules 117 may be assigned to particular texture identifiers and or they may be assigned to a plurality or group of texture identifiers. Similarly, Ad rules 117 may be uniformly applied across all texture identifiers as needed.

The Ad identifiers may be associated with the following bits of information, stored either locally in an Ad engine or remotely in an Ad server: Ad size; Ad shape; Ad background color; ad type (video or static texture); intended viewer demographic (including user age range, sex, and/or household income); location specifier (which may user the PCD IP address to determine the PCD's location), and so forth; and impression threshold (using pixels displayed, key pixels, or the minimum mipmap sub-picture which must be displayed to make an impression, or other algorithm to determine an impression).

Once the Ad identifier is selected by the graphics driver 107 based on an appropriate Ad rule 117, then this Ad identifier may be matched with its corresponding dynamic advertisement 119 found in the texture database 112 as illustrated in FIG. 7. Further details about the texture database 112 as illustrated in FIG. 7 will be described below.

Referring back to FIG. 5, in block 525, the graphics driver 107 sends the dynamic advertisement 119 to the graphics processor 110B. In block 530, the graphics processor 110B generates the dynamic advertisement 119 according to the texture atlas 300E of FIG. 4 on the display device 132.

Next, in routine or submethod decision block 535, the graphics driver 107 may continuously monitor dynamic advertisements 119 that are positioned in areas proximate to the screen pointer 307 as illustrated in FIG. 3C. In this routine decision block 535, the graphics driver 107 may determine if a dynamic advertisement 119 is unobstructed relative to any video objects 111 and if the advertisement 119 is viewable within the screen display 132. Further details about this routine or submethod decision block 535 will be described in further detail below in connection with FIG. 6.

If the inquiry to decision block 535 is positive, then the “YES” branch is followed to block 540. If the inquiry to decision block 535 is negative, then the “NO” branch is followed to decision block 545. In block 540, the graphics driver 107 may activate Ad view tracking. The Ad view tracking may comprise the graphics driver 107 determining a length of time or a number of times or both of when a dynamic advertisement 119 is fully viewable within a screen display 132. One of ordinary skill in the art may refer to this as a commercial impression metric that measures how often a dynamic advertisement 119 is available for a complete or full view by the operator of the PCD 100B while a PCD video games being executed.

Next, in decision block 545, the graphics driver 107 may determine if an operator of the PCD 100B has selected or “clicked-on” a dynamic Ad 119 in order to obtain more information about a particular product or service (or both) being advertised within the dynamic Ad 119. If the inquiry to decision block 545 is negative, then the “NO” branch is followed in which the method 500 returns.

If the inquiry to decision block 545 is positive, then the “YES” branch is followed to block 550 in which the graphics driver 107 may issue a command to the operating system 1152 launch a browser application. Alternatively, the graphics driver 107 may issue a command directly to a browser application to launch a new window within the screen display 132 in response to an operator the PCD 100B selecting or “clicking-on” a dynamic Ad 119 with the screen pointer 307.

Next, in block 555, the browser application may be redirected to a webpage associated with the dynamic Ad 119 that was selected by the operator of the PCD 100B. This webpage may provide additional information about the product or service being advertised similar to that illustrated in FIG. 3D described above. In block 555, conventional Ad campaign tracking techniques may be activated in this block as understood by one of ordinary skill in the art and as described in further detail below in connection with FIG. 8.

FIG. 6 is a logical flowchart illustrating a submethod or routine 535 of FIG. 5 for determining if a dynamic advertisement 119 within a PCD video game is blocked from view relative to the operator. Block 605 is the first step of submethod 535. In block 605, the graphics driver 107 may request the depth buffer 113 to provide its current depth values for a current iteration of the screen display 132 that comprises a dynamic Ad 119. The depth values may be calculated by the graphics processor 110B. According to an exemplary embodiment, only a few depth buffer values are sampled instead of using all values contained within the depth buffer 113. In this way, speed of performance in connection with this submethod 535 may be increased in view of the reduced calculations made from taking fewer values.

In block 610, the graphics driver 107 may determine if the dynamic Ad 119 is unobstructed or obstructed by the video object 111 based on these depth values calculated by the graphics processor 110B that may be stored in the depth buffer 113. As noted previously in block 605, the graphics driver 107 may use all values within the depth buffer 113 or a sample of values. These depth buffer values are compared to depth values for each dynamic Ad 119.

For example, as described above in connection with FIG. 3, the graphics driver 107 utilizing the depth buffer 113 may determine a percentage of blockage relative to the dynamic Ad 119A1. A threshold percentage of blockage may be set or established in this block 610 for the graphics driver 107 to follow. In other words, a certain percentage of blockage relative to a dynamic Ad 119A1 may be tolerable meaning that most or a majority of the dynamic Ad 119A1 may be visible to the operator of the PCD 100B.

For example, in FIG. 3A, the graphics driver 107 utilizing the depth buffer 113 may discover that the video object 111 comprising the race car may be blocking approximately 100% of the dynamic Ad 119A1. In such a scenario, the inquiry to decision block 535 would be negative meaning that the graphics driver 107 would not activate any Ad view tracking since the contents of the dynamic advertisement would not be comprehendible by the operator of the PCD 1008.

Conversely, in FIG. 3C, the graphics driver 107 utilizing the depth buffer 113 may discover that the video object 111 comprising the race car may not be blocking any portion of the dynamic advertisement 119 (0% of blockage). In such a scenario, the inquiry to decision block 535 would be positive meaning that the graphics driver 107 would start activating Ad view tracking since the contents of the dynamic advertisement 119 would be completely visible and understandable by the operator of the PCD 100B.

In block 610, the graphics driver 107 may also determine if the dynamic Ad 119 has the requisite size to be viewable on the display device 132. As noted previously, in a PCD video game which has perspective in a three-dimensional context, some objects like the dynamic Ads 119 will be scaled based on their relative distance to a viewing point in the game. For example, a bill board sign containing a dynamic Ad 119 may be generated so that it appears to be several “virtual” miles from the current view being displayed on the screen display 132. The graphics driver 107 may check the size of the dynamic Ad 119 based on values listed in a chart, such as chart 700 described below in connection with FIG. 7. Chart 700 may be stored in the texture database 112. Chart 700 comprises a size column 715 that lists minimum dimensions of a dynamic Ad 119 for it to be considered viewable or comprehendible within a display screen 132. The submethod 535 then returns back to either block 540 or block 545 of FIG. 5. FIG. 7 is a chart 700 illustrating additional exemplary contents of a texture database 112. The chart may comprise a texture Ad identifier column 705, an Ad campaign number column 710, an Ad size/shape column 715, and an Ad aspect ratio column 720. The texture Ad identifiers in the texture Ad identifier column 705 generally correspond with the Ad identifiers listed in the Ad identifier column 407 of FIG. 4. The Ad size/shape column 715 may provide the relative dimensions of a dynamic Ad 119 measured in pixels. These relative dimensions may define a minimum size for a dynamic Ad 119 to be considered viewable and counted towards a commercial impression as will be described below in connection with FIG. 8. This column 715 may also identify the relative geometric shape for particular dynamic Ad 119. The graphics driver 107 may pass the contents of the chart 700 to the graphics processor 110B as needed when a dynamic Ad 119 needs to be generated and positioned within the texture atlas 300D as the illustrated in FIG. 4. One of ordinary skill the art will recognize that other dynamic Ad parameters may be provided within chart 700 without departing from the scope of this disclosure. For example, chart 700 may be edited by a PCD operator to mark Ad textures with Ad campaigns and Ad identifiers, without having to edit the source or object code of the game itself, i.e. by simply changing the data structures used to create 3-D levels of the game.

FIG. 8 is a chart 800 illustrating exemplary tracking options for dynamic advertisements 119 within a PCD video game. Each dynamic Ad 119 may be tracked when (1) the dynamic Ad 119 is shown to the operator of the PCD 100B as well as (2) when the PCD operator selects and “clicks-on” or “clicks-through” a dynamic Ad 119 with a screen pointer 307 or another similar user interface. The graphics driver 107 may be responsible for these tracking features and it may relay data back to the computer server 100A.

Specifically, the graphics driver 107 may work with the computer server 100A to track advertising billing data to enable billing methods including, but not limited to, the following: Cost Per Mille (“CPM”); Cost Per Clickthrough (“CPC”); Cost Per Action (“CPA”); Cost Per Day (“CPD”); and Pay per click (“PPC”). CPM, as understood by one of ordinary skill in the art, is a fee paid by advertisers to show a dynamic Ad 119 to one-thousand customers. CPM is based on the metric, Cost Per Impression (“CPI”) which involves only a single commercial impression. A single commercial impression occurs when a dynamic Ad 119 is shown on a screen display 132 for one instance. As of this writing, typical fees for CPM range between approximately $1 (U.S.) to approximately $20 (U.S.) for landline Internet dynamic Ads 119. However, other ranges for fees described in this disclosure are feasible as understood by one of ordinary skill in the art.

CPC, as understood by one of ordinary skill in the art, is a pay-for-performance fee paid by an advertiser for each user that clicks on an Ad 119. As of this writing, typical fees for CPC range between approximately $0.10 (U.S.) to approximately $0.60 (U.S.) per click-through for landline Internet Ads.

CPA, as understood by one of ordinary skill in the art, is a fee paid only when a user does a prescribed action on a website. For example, one action may include a user buying a product that was launched in response to the user clicking on the dynamic advertisement 119. As of this writing, typical fees for CPA range widely between goods and services offered. For example, some CPAs range up to $100 (U.S/) per action in industries like new car sales. CPA may include Cost per click Through, Cost per lead (“CPL”), Cost per sale (“CPS”), and Dynamic CPM (“dCPM”).

CPD, as understood by one of ordinary skill in the art, usually includes dynamic Ads 119 that may be shown an unlimited number of times per day (week, month, etc.). The metric typically usually has a minimum number of showings as part of a contract.

PPC, as understood by one of ordinary skill in the art, is an Internet advertising model used on websites. It is a model in which advertisers may pay their host only when their dynamic Ad 119 is clicked.

The server 100A may comprise an Ad server. An Ad server usually comprises a web server 100A that stores advertisements 119 used in online marketing and delivers them to website visitors. The content of the web server 100A may be constantly updated so that the video games in which the Ads 119 are displayed contain new advertisements 119—e.g., banners (static images/animations) or text—when the PCD video game is re-started or refreshed by a user. In addition, the server 100A may include “tracking URLs” (not depicted) that are fetched by the Ad engine when an ad is displayed to the user, and later, a different “tracking URL” may be fetched to report a click-through action by the user.

The Ad server 100A may work with the graphics driver 107 and the Ad rules 117B of the PCD 100B to perform various other tasks, such as tracking the advertising data described above, for an Ad campaign and for generating reports. This tracking by the Ad server 107 and the graphics driver 107 may help an advertiser determine his or her return-on-investment (“ROI”) for a particular PCD video game.

The Ad server 100A may comprise a local Ad server 100A or one or more third-party/remote Ad server(s) 100A. Local Ad servers 100A are typically managed by a single publisher and serve Ads 119 to a publisher's domains, allowing fine-grained creative, formatting, and content control by that publisher. Remote Ad servers 100A may serve dynamic Ads 119 across domains owned by multiple publishers/advertisers and/or product and service vendors. Remote Ad servers are typically owned and controlled by an Ad Network. The server 100A may deliver dynamic Ads 119 from one central source so that advertisers and publishers may track the distribution of their online advertisements within PCD video games. A single sever 100A may be housed in one location for controlling the rotation and distribution of dynamic Ads 119 within multiple PCD video games.

The Ad server 100A may support at least the following functions: Uploading dynamic Ads 119 and rich media from advertisers, product vendors, and/or service vendors; tracking Ads 119 according to differing business rules 117; targeting Ads 119 to different users of PCD video games; tuning and optimizing Ads 119 based on results; and reporting the advertising data (i.e. CPI, CPM, CPC, etc.) described above.

The Ad server 100A in combination with the graphics driver 107 and with the Ad rules 117B may also implement Ad-frequency capping so users only see messages a limited amount of time within the PCD video game. The Ad server 100A working with the graphics driver 107 may also limit Ads 119 by setting a frequency cap on money-spending provided by an advertiser. The Ad server 100A may also sequence Ads 119 through the graphics driver 107 and with the Ad rules 117B so users see messages in a specific order (known to one of ordinary skill in the art as surround sessions).

The Ad server 100A working with the graphics driver 107 and the Ad rules 117B may also exclude competition so users of the PCD video game do not see competitors' Ads directly next to one another. The Ad server 100A may display dynamic Ads 119 within a video game so an advertiser may own one-hundred percent of the inventory (products and/or services) in a single scene within the PCD video game (known to one of ordinary skill in the art as “Roadblocks”).

The Ad server 100A working with the graphics driver 107 and through the Ad rules 117B of the PCD 100B may target Ads 119 to users based on their previous behavior (behavioral marketing or behavioral targeting) relative to actions taken during a PCD video game. This may include behavioral targeting. Behavioral target marketing may include using a profile of prior behavior on the part of the PCD video game viewer to determine which Ad 119 to show during a subsequent iteration of the PCD video game. For example, car Ads may be displayed during the PCD video game to a viewer that was known to have visited car websites based on Ads 119 that were clicked-on or clicked-through in a previous “play” of the PCD video game.

The graphics driver 107 may support contextual targeting of dynamic advertisements 119. For example, the graphics driver 107 may infer optimum Ad placement from information contained on a particular screen within the PCD video game while the Ad 119 is being displayed on a screen display 132. For example, the graphics driver 107 may place tire Ads 119 automatically in a screen on virtual bill boards within the PCD video game when a race car 111 is moving passed the billboards, such as illustrated in FIGS. 3A-3C. The graphics driver 107 may use experimental or predictive methods to determine the optimum showing for a given Ad placement and it may exploit the resulting determination in future impressions of the Ad 119.

With respect to the Ad server 100A and graphics driver 107 tracking revenue of the dynamic Ads 119 within the PCD game context, in terms of cost-per-mille charging (CPM), what counts as an impression may be calculated in at least two ways. According to a first method, an impression may be defined as the dynamic Ad 119 being shown (displayed) on a single game level. If the operator of the PCD 100B goes up a level and then goes back down a level, then the advertiser for a particular dynamic Ad 119 may be charged for two impressions. The impressions in these instances would be tracked by the graphics driver 107 working together with the Ad Server.

Usually, an impression of a dynamic Ad 119 requires that the Ad shown be a certain minimum size on the screen. The problem in a three-dimensional PCD video game context is that the dynamic Ad 119 may be on a virtual billboard two miles from the PCD video game player, and it might be one pixel in size on the screen. So the advertiser given this scenario may require a certain minimum number of pixels for the advertisements (i.e. a 350×100 pixel Ad 119, at least 50% in size or 175×50 must be viewable by the user). This relative size of the dynamic Ads 119 may be stored in chart 700 in column 715. The graphics driver 107 may track this relative size of the dynamic Ads 119 and relay this data to the Ad server 100A.

Alternately the size of a dynamic Ad 119 may be measured based on selection among several choices in the “mipmap” that is used for Ad 119 display on the screen. The mipmap, if implemented, contains the Ad 119 at several different resolutions and the graphics driver 107 selects the most appropriate size (or two sizes, if the graphics driver 107 intends to interpolate between the two sizes). In such a system, the Ad size/shape 715 may be stored not as pixels, but based on mipmap versions of the Ad that are selected for display. Other ways to determine an impression exist, but one of ordinary skill in the art will recognize that additional methods for determining an impression based upon Ad size/shape and/or critical Ad pixels may also be defined.

In terms of cost-per-click through (CPC) for the PCD video game context, how the graphics driver 107 recognizes a click-through (when the PCD video game itself is usually reading input from the keyboard 117 or mouse while the graphics driver 107 does not have access to the keyboard 117 or a mouse key) has been an issue in the conventional art. For example, a click-through should not be understood by a PCD video game to be a gun-firing event (in a gun-shooting PCD video game context), when the operator of the PCD 100B really meant to click-through on the Ad 119 present on the screen display 132 while the game is being played.

One solution to this problem is that an operator playing the PCD video game may hit an “escape” key of some sort that notifies the graphics driver 107 that the operator is about to execute a click-through. The PCD video game may have a pre-configuration to not to use this escape key or the combination of this key coupled with a mouse click. The graphics driver 107 may reserve this key combination and make it impossible for the PCD video game to read this combination of keys.

When a PCD operator does click-through of a dynamic Ad 119 presented in PCD video game context, the system 101 may provide at least two different click-through methods. First, a click-through may be saved in memory 112 and executed later, such as during a level change within play of the PCD video game.

A second alternative method is that the PCD video game-world may be frozen while the browser is launched, as described above in connection with FIG. 5. This method may allow the operator of the PCD 100B to resume the PCD video game-world when they are done with the click-through event. As an incentive to perform a click-through, in certain locations of the game a click-through might be the only way to pause the game in a particular location or room. However, other methods for presenting additional information about a clicked-through dynamic Ad 119 are possible and within the scope of this disclosure as understood by one of ordinary skill in the art.

With this system 101, dynamic Ads 119 may be played in PCD video games without the need for a game developer to change the original coding for a game. The system 101 allows a game developer to change and alternate Ads 119 with a simple interface and without the need to modify any game code.

With this system 101, dynamic Ads 119 may additionally be inserted into a PCD video game 105 by use of a simple “level editor” that is common used to modify the structure of the maps presented in a 3-D video game. By editing the room shapes and sizes and most importantly, texture maps, to create space for dynamic Ads 119, an operator without significant programming skills may modify a video game 105 to display dynamic Ads 119 by simply modifying the textures to mark insertion points and ad genres/scene-types to help with the targeting of the Ad 119.

In view of the disclosure above, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the FIGs. which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

1-56. (canceled)

57. A method for tracking dynamic advertisements within a program running on a portable computing device (PCD) comprising:
in accordance with one or more Ad rules stored on the PCD, selecting a dynamic advertisement using information in a texture database stored on the PCD;
displaying the dynamic advertisement on a screen display; and
determining if a video object produced by the program blocks a portion of the dynamic advertisement present on the screen display, wherein the portion of the dynamic advertisement comprises content defined by a provider of the dynamic advertisement.

58. The method of claim 57, wherein determining if the video object produced by the program blocks a portion of the dynamic advertisement present on the screen display comprises assessing at least one value assigned to the three-dimensional coordinates forming the video object and at least one value assigned to the three-dimensional coordinates forming the dynamic advertisement.

59. The method of claim 57, wherein the dynamic advertisement is defined by a plurality of key points and wherein determining if the video object produced by the program blocks a portion of the dynamic advertisement present on the screen display comprises determining if a threshold level of the key points are not visible by a depth buffer stored on the PCD.

60. The method of claim 57, wherein the dynamic advertisement is defined by a plurality pixels and wherein determining if the video object produced by the program blocks a portion of the dynamic advertisement present on the screen display comprises determining if a threshold level of pixels of the dynamic advertisement are not being displayed on the screen display.

61. The method of claim 57, wherein determining if the video object produced by the program blocks a portion of the dynamic advertisement present on the screen display comprises determining if the video object produced by the program blocks a threshold percentage of the dynamic advertisement.

62. The method of claim 57, further comprising:
activating a view tracking feature if the video object blocks a portion of the dynamic advertisement.

63. The method of claim 57, wherein determining if the video object produced by the program blocks a portion of the dynamic advertisement present on the screen display further comprises evaluating at least one of all values within a depth buffer and a sampling of values within a depth buffer.

64. The method of claim 63, further comprising:
calculating the depth values with a graphics processor and storing the depth values in the depth buffer.

65. The method of claim 57, wherein determining if a video object produced by the program blocks a portion of the dynamic advertisement present on the screen display further comprises reviewing a sub-picture displayed from a mipmap and using a minimum mipmap Ad size to achieve a threshold of a commercial impression.

66. The method of claim 57, further comprising:
determining if an identifier associated with a texture matches an identifier in the texture database; and
selecting a dynamic advertisement using information in the texture database if the identifier associated with the texture matches the identifier in the texture database.

67. A computer system for tracking dynamic advertisements within a program running on a portable computing device (PCD), the system comprising:
a processor operable to:
select a dynamic advertisement, in accordance with one or more Ad rules stored on the PCD, and using information in a texture database stored on the PCD;
display the dynamic advertisement on a screen display; and
determine if a video object produced by the program blocks a portion of the dynamic advertisement present on the screen display, wherein the portion comprises content defined by a provider of the dynamic advertisement.

68. The system of claim 67, wherein determining if the video object produced by the program blocks a portion of the dynamic advertisement present on the screen display comprises assessing at least one value assigned to the three-dimensional coordinates forming the video object and at least one value assigned to the three-dimensional coordinates forming the dynamic advertisement.

69. The system of claim 67, wherein the dynamic advertisement is defined by a plurality of key points and wherein determining if the video object produced by the program blocks a portion of the dynamic advertisement present on the screen display comprises determining if a threshold level of the key points are not visible by a depth buffer stored on the PCD.

70. The system of claim 67, wherein the dynamic advertisement is defined by a plurality pixels and wherein determining if the video object produced by the program blocks a portion of the dynamic advertisement present on the screen display comprises determining if a threshold level of pixels of the dynamic advertisement are not being displayed on the screen display.

71. The system of claim 67, wherein determining if the video object produced by the program blocks a portion of the dynamic advertisement present on the screen display comprises determining if the video object produced by the program blocks a threshold percentage of the dynamic advertisement.

72. The system of claim 67, wherein the processor is further operable to:
activate a view tracking feature if the video object blocks a portion of the dynamic advertisement.

73. The system of claim 67, wherein the processor operable to determine if the video object produced by the program blocks a portion of the dynamic advertisement present on the screen display further comprises the processor operable to evaluate at least one of all values within a depth buffer and a sampling of values within a depth buffer.

74. The system of claim 73, wherein the depth values are calculated by a graphics processor and stored in the depth buffer.

75. The system of claim 67, wherein determining if a video object produced by the program blocks a portion of the dynamic advertisement present on the screen display further comprises reviewing a sub-picture displayed from a mipmap and using a minimum mipmap Ad size to achieve a threshold of a commercial impression.

76. The system of claim 67, wherein the processor is further operable to:
determine if an identifier associated with a texture matches an identifier in the texture database; and
select a dynamic advertisement using information in the texture database if the identifier associated with the texture matches the identifier in the texture database.

77. A computer system for tracking dynamic advertisements within a program running on a portable computing device (PCD) comprising:
in accordance with one or more Ad rules stored on the PCD, means for selecting a dynamic advertisement using information in a texture database stored on the PCD;
means for displaying the dynamic advertisement on a screen display; and
means for determining if a video object produced by the program blocks a portion of the dynamic advertisement present on the screen display, wherein the portion of the dynamic advertisement comprises content defined by a provider of the dynamic advertisement.

78. The system of claim 77, wherein means for determining if the video object produced by the program blocks a portion of the dynamic advertisement present on the screen display comprises means for assessing at least one value assigned to the three-dimensional coordinates forming the video object and at least one value assigned to the three-dimensional coordinates forming the dynamic advertisement.

79. The system of claim 77, wherein the dynamic advertisement is defined by a plurality of key points and wherein means for determining if the video object produced by the program blocks a portion of the dynamic advertisement present on the screen display comprises means for determining if a threshold level of the key points are not visible by a depth buffer stored on the PCD.

80. The system of claim 77, wherein the dynamic advertisement is defined by a plurality pixels and wherein means for determining if the video object produced by the program blocks a portion of the dynamic advertisement present on the screen display comprises means for determining if a threshold level of pixels of the dynamic advertisement are not being displayed on the screen display.

81. The system of claim 77, wherein means for determining if the video object produced by the program blocks a portion of the dynamic advertisement present on the screen display comprises means for determining if the video object produced by the program blocks a threshold percentage of the dynamic advertisement.

82. The system of claim 77, further comprising:
means for activating a view tracking feature if the video object blocks a portion of the dynamic advertisement.

83. The system of claim 77, wherein means for determining if the video object produced by the program blocks a portion of the dynamic advertisement present on the screen display further comprises means for evaluating at least one of all values within a depth buffer and a sampling of values within a depth buffer.

84. The system of claim 83, further comprising:
means for calculating the depth values with a graphics processor and storing the depth values in the depth buffer.

85. The system of claim 77, wherein means for determining if a video object produced by the program blocks a portion of the dynamic advertisement present on the screen display further comprises means for reviewing a sub-picture displayed from a mipmap and using a minimum mipmap Ad size to achieve a threshold of a commercial impression.

86. The system of claim 77, further comprising:
means for determining if an identifier associated with a texture matches an identifier in the texture database; and
means for selecting a dynamic advertisement using information in the texture database if the identifier associated with the texture matches the identifier in the texture database.

87. A computer program product comprising a computer usable medium having a computer readable program code embodied therein, said computer readable program code adapted to be executed to implement a method for tracking dynamic advertisements within a program running on a portable computing device (PCD), said method comprising:
in accordance with one or more Ad rules stored on the PCD, selecting a dynamic advertisement using information in a texture database stored on the PCD;
displaying the dynamic advertisement on a screen display; and
determining if a video object produced by the program blocks a portion of the dynamic advertisement present on the screen display, wherein the portion of the dynamic advertisement comprises content defined by a provider of the dynamic advertisement.

88. The computer program product of claim 87, wherein determining if the video object produced by the program blocks a portion of the dynamic advertisement present on the screen display comprises assessing at least one value assigned to the three-dimensional coordinates forming the video object and at least one value assigned to the three-dimensional coordinates forming the dynamic advertisement.

89. The computer program product of claim 87, wherein the dynamic advertisement is defined by a plurality of key points and wherein determining if the video object produced by the program blocks a portion of the dynamic advertisement present on the screen display comprises determining if a threshold level of the key points are not visible by a depth buffer stored on the PCD.

90. The computer program product of claim 87, wherein the dynamic advertisement is defined by a plurality pixels and wherein determining if the video object produced by the program blocks a portion of the dynamic advertisement present on the screen display comprises determining if a threshold level of pixels of the dynamic advertisement are not being displayed on the screen display.

91. The computer program product of claim 87, wherein determining if the video object produced by the program blocks a portion of the dynamic advertisement present on the screen display comprises determining if the video object produced by the program blocks a threshold percentage of the dynamic advertisement.

92. The computer program product of claim 87, wherein the program code implementing the method further comprises:
activating a view tracking feature if the video object blocks a portion of the dynamic advertisement.

93. The computer program product of claim 87, wherein determining if the video object produced by the program blocks a portion of the dynamic advertisement present on the screen display further comprises evaluating at least one of all values within a depth buffer and a sampling of values within a depth buffer.

94. The computer program product of claim 93, wherein the program code implementing the method further comprises:
calculating the depth values with a graphics processor and storing the depth values in the depth buffer.

95. The computer program product of claim 87, wherein determining if a video object produced by the program blocks a portion of the dynamic advertisement present on the screen display further comprises reviewing a sub-picture displayed from a mipmap and using a minimum mipmap Ad size to achieve a threshold of a commercial impression.

96. The computer program product of claim 87, wherein the program code implementing the method further comprises:
determining if an identifier associated with a texture matches an identifier in the texture database; and
selecting a dynamic advertisement using information in the texture database if the identifier associated with the texture matches the identifier in the texture database.
